(19) United States
(12) Patent Application Publication
(10) Pub. No.: US 2010/0166527 A1
(43) Pub. Date: Jul. 1, 2010

(54) BINDING ASSEMBLY

(75) Inventor: G. Roland Hill, Cheshire (GB)

Correspondence Address: PILLSBURY WINTHROP SHAW PITTMAN, LLP, P.O. BOX 10500, MCLEAN, VA, 22102, US

(73) Assignee: Contra Vision Limited, Bramhall, Cheshire (GB)

(21) Appl. No.: 12/376,855

(22) PCT Filed: Aug. 23, 2007
(86) PCT No.: PCT/IB07/02452

§ 371 Date: Feb. 9, 2009

Related U.S. Application Data
(60) Provisional application No. 60/839,422, filed on Aug. 23, 2006.

(51) Int. Cl. B42C 7/00

(52) U.S. Cl. 412/17

(57) ABSTRACT

An assembly includes two sheets which are superimposed, wherein one edge of one of the sheets is aligned with an edge of the other sheet. The assembly also includes a tape connecting the two edges, the tape having opposing and offset layers of adhesive. One of said layers of adhesive is disposed on one side of said tape and the other of said layers of adhesive is disposed on the other side of said tape, and wherein said one of said layers of adhesive is attached to the outside of one said sheet and said other of said layers of adhesive is attached to the inside of said other sheet.

### CROSS-REFERENCE

This application claims the benefit of priority from U.S. Provisional Patent Application Ser. No. 60/839,422, titled “Binding Assembly,” filed Aug. 23, 2006, the entire contents of which are hereby incorporated by reference.

### BACKGROUND OF THE INVENTION

1. Field of the Invention

The present invention relates generally to binding assemblies, and relates specifically to covers for reports, etc.

2. Description of Related Art

Various means of connecting two sheets to comprise a document or to comprise the rear and front cover of a document or a loose leaf folder are known. The application of adhesives to opposing surfaces of a single tape is known, for example in the production of “double-sided tape.” The application of adhesives in discrete “zones” is known. Co-pending PCT patent application publication no. WO 2007/052156 A2, titled “Structural Assembly with a Tied, Flexurally Deformed Panel” (TYFLEX®), filed Aug. 21, 2006, discloses the use of a self-adhesive tape with opposing, offset “zones” of adhesive to connect the outside of a first sheet and the inside of a second sheet, the second sheet being typically more flexible than the first sheet (see FIGS. 22E-H).

### SUMMARY OF THE INVENTION

According to one aspect of the invention, an assembly comprises two sheets which are superimposed, wherein one edge of one of the sheets is aligned with an edge of the other sheet, and wherein the two edges are connected by a tape having opposing and offset layers of adhesive, wherein one of said layers of adhesive is disposed on one side of said tape and the other of said layers of adhesive is disposed on the other side of said tape, and wherein said one of said layers of adhesive is attached to the outside of one said sheet and said other of said layers of adhesive is attached to the inside of said other sheet.

In the context of this invention, the term “aligned” means in a desired geometric relationship, the “one edge of one of the sheets is aligned with an edge of the other sheet” means that the designated edges are in a desired geometric relationship, typically two straight, parallel edges.

The tape binds the two sheets together and typically allows rotation of the one sheet in relation to the other sheet, for example in the manner of cover and backing sheets to contain loose or separately bound papers.

A “sheet” typically comprises two plane, parallel surfaces in repose and is optionally

(i) a stiff sheet, for example of cardboard or metal, for example steel or aluminum, semi-rigid plastic, for example acrylic, PVC or polycarbonate, or

(ii) a flexible sheet, for example of paper or plastic film, for example polyester, acrylic, PVC, polycarbonate, PVC or acetate. The sheets on plan are typically rectangular or optionally of other shape, for example semi-circular or triangular, typically having straight, bound edges.

A sheet optionally has a surface treatment on one or both sides, for example a coating or a graphic design, for example printed or hand applied.

The “tape” is typically flexible plastic film, for example polyester or PVC, or fabric, for example woven polyester or cotton.

The “adhesive” is optionally pressure-sensitive adhesive, for example an acrylic, solvent-based pressure-sensitive adhesive, or optionally a heat-activated adhesive, or is any adhesive known in the art of book, magazine and report binding. Alternatively, the adhesive may be any other suitable adhesive, as would be understood by one of ordinary skill in the art.

The layers of adhesive on opposing sides of the tape are offset and typically have outer edges of adhesive coterminous with the tape edges and either:
(i) the two layers of adhesive do not overlap, or
(ii) the two inside edges of the adhesive layers are coterminous, or
(iii) the two layers of adhesive overlap.

The assembly is optionally limited to the two bound sheets with adhered binding tape or optionally comprises or contains another element or elements, for example bound sheets of paper.

Additional and/or alternative objects, features, aspects, and advantages of the present invention will become apparent from the following description, the accompanying drawings, and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIGS. 1-4 are diagrammatic cross-sections of conventional assemblies;

FIGS. 5-7 are diagrammatic cross-sections of assemblies according to various embodiments of the present invention;

FIGS. 8-10 are diagrammatic cross-sections of tape according to various embodiments of the present invention;

FIGS. 11-12 are diagrammatic cross-sections of assembly shown in FIG. 5;

FIGS. 13-14 are diagrammatic cross-sections of an assembly according to another embodiment of the present invention; and

FIG. 15 is a perspective of the assembly of FIG. 5.

### DETAILED DESCRIPTION OF EMBODIMENTS OF THE INVENTION

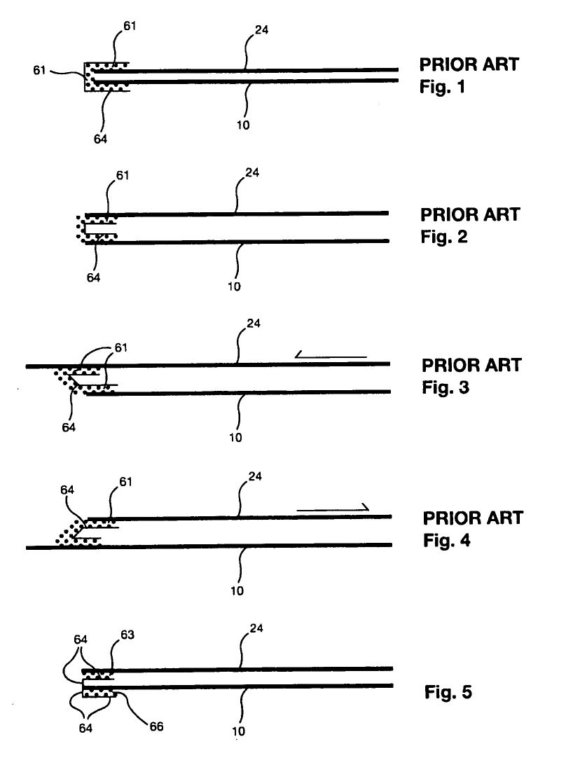

FIG. 1 illustrates the prior art connection of two superimposed sheets 10 and 24 by self-adhesive tape 64 and adhesive 61 wrapped around the outside of an edge of each sheet. This arrangement obscures or typically detracts from the appearance of, and especially any printed matter, display or other graphic on, the outer surface of one or both sheets.

FIG. 2 illustrates the prior art connection of two sheets by self-adhesive tape applied to an inside surface of both sheets. This arrangement suffers from the fact that adhesives, especially pressure-sensitive adhesives, are suspect to peeling, for example if an in-plane force is applied to one sheet and resisted by the other sheet, as illustrated in prior art FIG. 3 or 4.

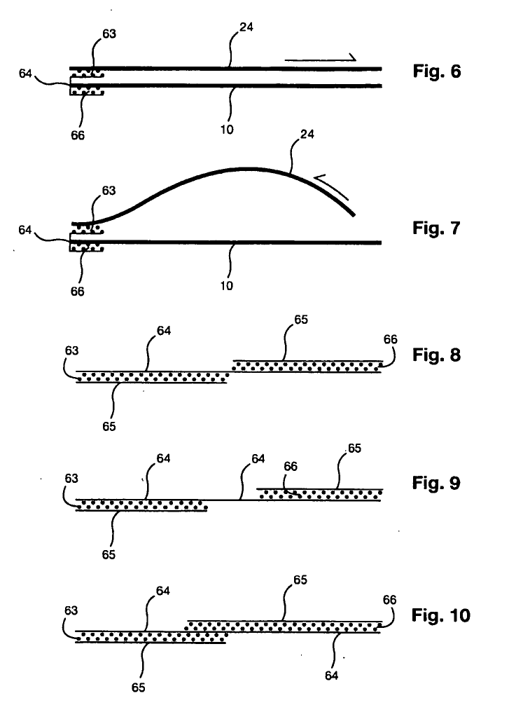

FIG. 5 illustrates a preferred embodiment of the invention, which comprises sheets 10 and 24, in which the adhesive layer 63 on one side of the tape 64 is applied to the outside of one sheet 10 and the other layer of adhesive 66 is applied to the inside surface of the other sheet 24. An in-plane force applied to the other sheet 24, in the direction away from the connected sheet edges, as illustrated in FIG. 6, will typically not cause any failure in the adhesive connection to either the first or second sheets, as the adhered surfaces are primarily in shear and not subject to the peeling action of the prior art. If an in-plane force is applied to sheet 24 towards the connected sheet edges, as illustrated in FIG. 7, because sheet 24 is relatively flexible compared to sheet 10, normal forces in use will tend to cause the other sheet 24 to flexurally deform and ultimately buckle before any significant peeling of the adhesive layer 63 takes place between sheet 24 and the tape 64. The sheets optionally comprise a graphic design, to be robustly attached to each other without visual obstruction from the connecting tape 64, for example to act as a document, or to act as a cover to loose leaf pages or bound pages of a single document. FIGS. 8, 9 and 10 are cross-sections through self-adhesive tapes comprising tape 64, one adhesive layer 63 and other adhesive layer 66 with release liners 65. In FIG. 8, an inside edge of one adhesive layer 63 is aligned coterminous with an inside edge of the other adhesive layer 66, whereas in FIG. 9 they are spaced apart and in FIG. 10 the adhesive layers overlap.

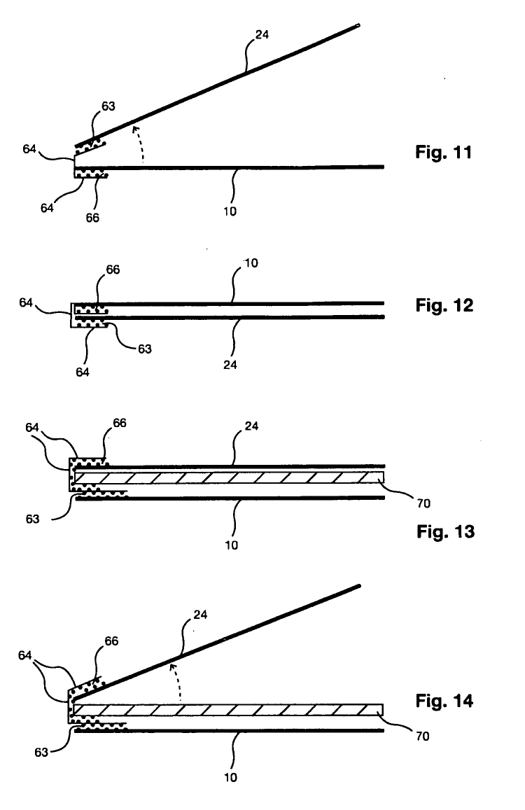

FIG. 11 illustrates the same assembly as FIG. 5, showing sheet 24 rotated relative to sheet 10, and FIG. 12 shows sheet 24 rotated 360° relative to sheet 10.

In FIG. 13, adhesive layer 66 overlaps adhesive layer 63, enabling adhesive layer 66 to adhere to and thus bind into the assembly another element 70, for example a document, for example sheets of printed paper that have been separately stapled, sewn or adhered together.

FIG. 14 shows cover sheet 24 being opened to reveal the document 70, which is otherwise protected by cover sheet 24.

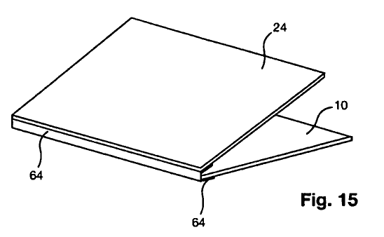

FIG. 15 is a perspective of the arrangement of FIG. 11, showing graphic design 80, for example the title of a document, applied to cover sheet 24.

Tapes, adhesives, and release liners of types commonly in use are preferably adopted for the invention, for example polyester film tape, acrylic, solvent-based pressure-sensitive adhesive and silicone-coated paper release liners.

Embodiments of the invention have been described mainly in relation to an assembly to protect bound or loose-leaf paper. However, there are many other uses for embodiments of the invention, including, for example, joining two sheets to form a flap mechanism, wherein the two sheets are capable of relative rotation.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. An assembly comprising:
two sheets which are superimposed, wherein one edge of one of the sheets is aligned with an edge of the other sheet; and
a tape connecting the two edges, the tape having opposing and offset layers of adhesive,
wherein one of said layers of adhesive is disposed on one side of said tape and the other of said layers of adhesive is disposed on the other side of said tape, and wherein said one of said layers of adhesive is attached to the outside of one said sheet and said other of said layers of adhesive is attached to the inside of said other sheet.

2. An assembly as claimed in claim 1, wherein said two layers of adhesive are coterminous with the tape edges.

3. An assembly as claimed in claim 1, wherein said two layers of adhesive do not overlap.

4. An assembly as claimed in claim 1, wherein said two layers of adhesive overlap.

5. An assembly as claimed in claim 1, wherein said two layers of adhesive have coterminous inside edges.

6. An assembly as claimed in claim 1, wherein said two sheets are capable of relative rotation.

7. An assembly as claimed in claim 6, wherein said tape acts as a hinge to enable said relative rotation.
